(19) United States
(12) Patent Application Publication
(10) Pub. No.: US 2012/0221530 A1
(43) Pub. Date: Aug. 30, 2012

(54) METHOD AND APPARATUS FOR VERIFYING STORED DATA

(76) Inventor: Karen Cook, Flower Mound, TX (US)

(21) Appl. No.: 13/034,364

(22) Filed: Feb. 24, 2011

(51) Int. Cl. G06F 17/30

(52) U.S. Cl. 707/687; 707/E17.005

(57) ABSTRACT

According to one aspect of the present invention, there is provided a method of verifying stored data that is associated with an owner. The method comprises selecting stored data to verify, generating, for an item of the selected data a unique key, associating the generated key with the corresponding data item and sending a communication to the owner associated with a selected data item, the communication including the generated key associated with that selected data item. The method further comprises receiving a response to the communication, the response identifying a key, determining from the response whether the data associated with the received key is valid; and associating the determination with the data in the database.

### BACKGROUND

Organizations and businesses store huge amounts of data in databases, spreadsheets, and other data repositories. Types of data that an organization may store, for example, include: personal data (such as home address, telephone number, bank details, etc. of their employees), asset details (such as details of equipment assigned to employees such as computers, mobile telephones, etc.), and employee data (such as job title, office address, office telephone number, etc).

For the vast majority of organizations and businesses it is important to know, for at least some types of data, that the stored data is valid or correct. However, determining whether this is the case is a particularly challenging task.

For data associated with human owners it is possible to perform audits, and to consult with the associated owners to ask them to confirm (or not, as the case may be) whether data associated with them is valid. However, current audit systems generally require a high degree of human intervention for both the auditor and the owner associated with the data. In many organizations performing an audit of, for example, asset data may require a substantial work effort, and may therefore only be performed infrequently. Consequently, the validity of the data may be difficult to determine.

### BRIEF DESCRIPTION

Embodiments of the invention will now be described, by way of non-limiting example only, with reference to the accompanying drawings, in which:

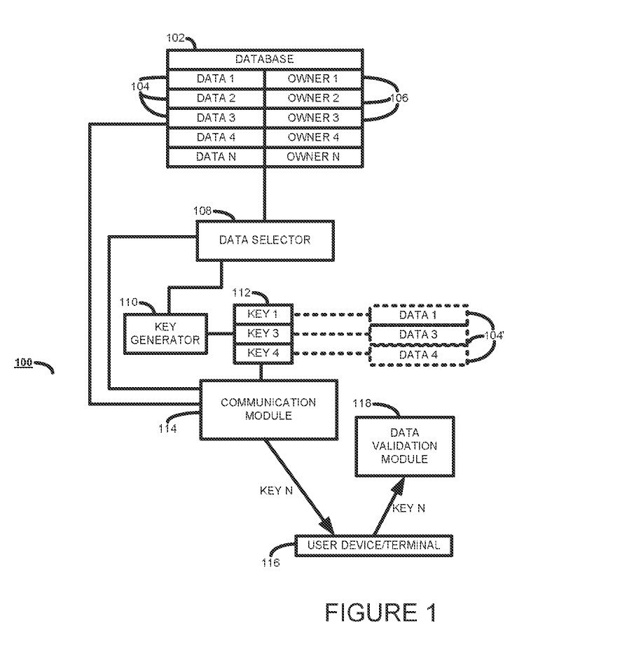

FIG. 1 is a simplified block diagram of a data validation system according to an example of the present invention;

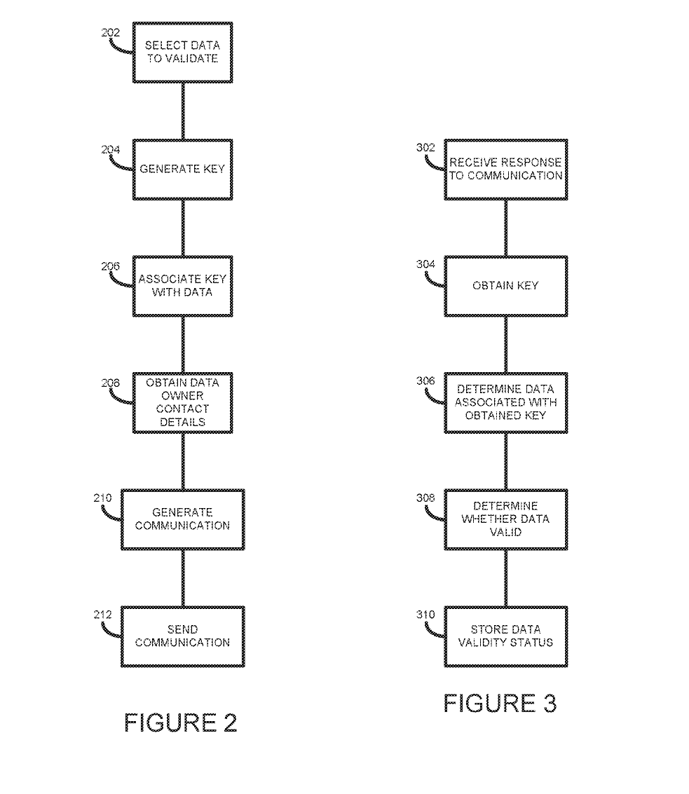

FIG. 2 is a simplified flow diagram outlining a method of operating elements of a data validation according to an example of the present invention;

FIG. 3 is a simplified flow diagram outlining a method of operating elements of a data validation according to an example of the present invention;

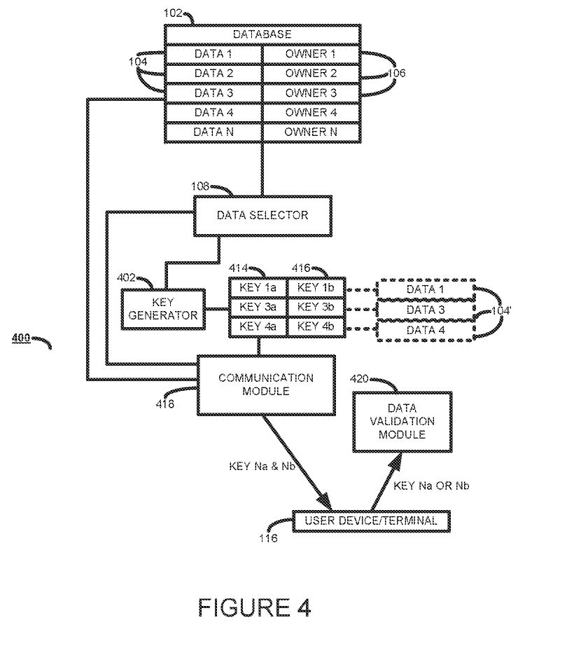

FIG. 4 is a simplified block diagram of a data validation system according to an example of the present invention;

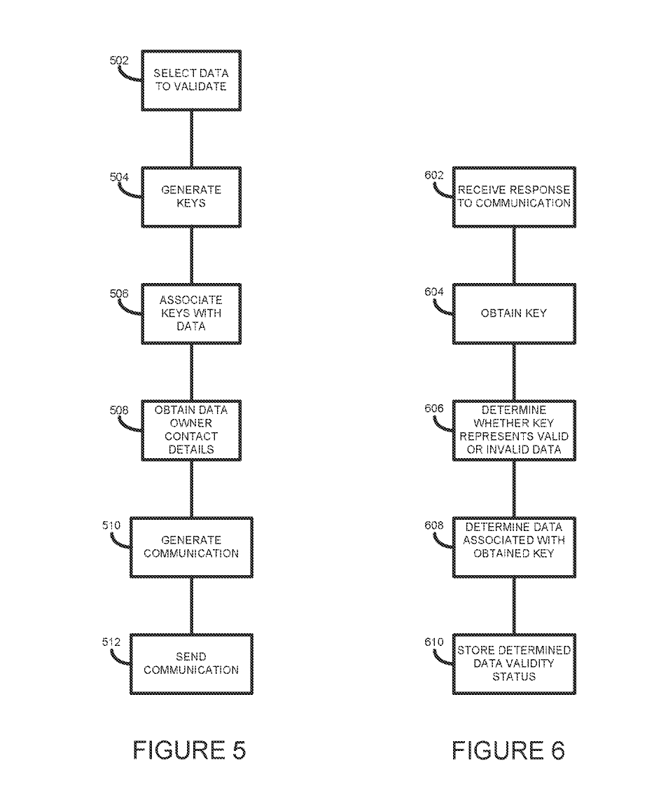

FIG. 5 is a simplified flow diagram outlining a method of operating elements of a data validation according to an example of the present invention;

FIG. 6 is a simplified flow diagram outlining a method of operating elements of a data validation according to an example of the present invention; and

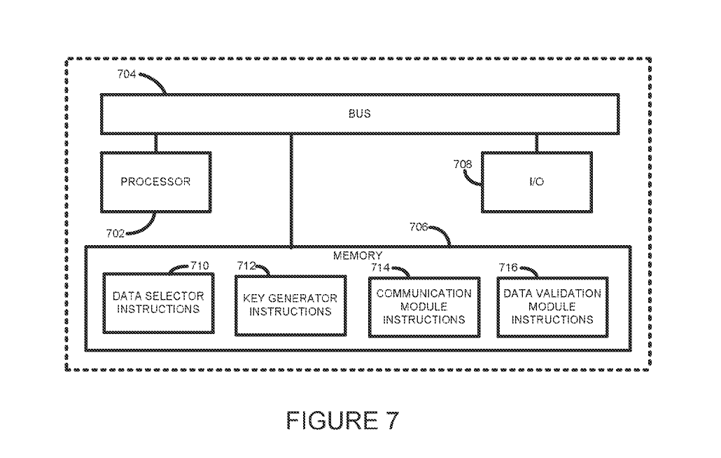

FIG. 7 is a simplified block diagram illustrating an example implementation of a data validation system according to an example of the present invention.

### DETAILED DESCRIPTION

Referring now to FIG. 1 there is shown a block diagram of a data validation or data audit system 100 according to an example of the present invention. Operation of elements of the system 100 is described with additional reference to FIGS. 2 and 3.

A database 102, or other suitable data repository, stores data items or objects 104. Each data item could represent different kinds of data such as, asset data, personal data, personnel data, sales data, etc.

Each data item 104 is associated with owner data 106 identifying an ‘owner’, or person or user, associated with the data. In one example the owner data includes an address or contact details at which the owner may be contacted, such as an email address, a telephone number, a network identifier, a video conferencing identifier, an instant messaging address, or the like.

In another example the owner data includes owner identification data through which owner contact details may be obtained. For example, the owner data may identify the name of a person associated with the data, and the contact details of the identified person may be resolvable or obtainable through an organization or enterprise directory, phone book, address book, or the like.

A data selector 108 selects (202, FIG. 2) a portion of the data 104 in the database 102 to validate. The selected data 104′ may, in some examples, include all of the data 104 in the database 102. In other examples, however, only a sub-set of the data 104 is selected. The data selector 108 may select data 104 to validate in various different manners. For example, in large organizations and businesses it may be undesirable to validate all of the data in the database 102, since doing so may impact both network and employee performance. The data selector 108 may, therefore, select a statistically representative sub-set of the data 104 to validate, and then use the results to infer the degree of validity of the whole set of the data 104 stored in the database 102.

In one example, the data selector 108 selects data based on a characteristic of what the data represents. For example, if the data 104 represents employee data, the data selector 108 may randomly select data associated with a number of different employees in each of the different departments of the organization. If the data 104 represents asset data, the data selector 108 may select a random selection of each of a number of different types of assets, such as computer servers, desktop computers, smart-phones, etc. Indeed, any suitable data selection strategy may be employed.

For each selected data item 104′ a key generator 110 generates (204) a unique key 112, such as a universally unique identifier (UUID), a globally unique identifier (GUID), or the like. The unique key may be generated in any suitable manner, for example, using a hash function, a random number generator, a cryptographic function, using a unique identifier generator service, or the like. In at least some examples the unique key is generated in such a way that a person intercepting the key in an unauthorized manner would be unable to guess or determine how the key how was generated, thereby preventing the validation system from being compromised (or at least rendering it difficult for the validation system to be compromised).

At 206 the key generator 110 associates the generated key 112 with the selected data item 104′.

In one example the association of the generated key 112 with a selected data item 104′ is achieved by the data selector 108 making a temporary copy of the selected data 104′, for example, in a database or memory (not shown). In another example, the association is achieved by associating the generated key 112 with the selected data 104 directly in the database 102.

Once a key 112 has been generated for a selected data item 104 a communication module 114 obtains (208) contact details for the owner associated with the selected data 104. The owner contact details may, in one example, be obtained directly from the database 102. In another example, the owner contact details may be obtained indirectly through use of the owner data 106, for example, by resolving or looking up an owner name in a suitable organization directory.

The obtained contact details may be any suitable contact details that enable an electronic communication to be sent or established with the owner. For example, contact details may be an email address to which an email message may be sent, or a telephone number to which a short message system (SMS) message may be sent. In one example the contact details may be a telephone number with which a telephone communication may be established for example using an appropriate interactive voice response (IVR) module (not shown).

At 210 the communication module 114 generates and sends (212) a communication to the obtained contact details of the owner associated with the selected data 104. For example, if the obtained contact details relate to an email address or SMS message, the communication module 114 generates and sends an appropriate email or SMS message.

The generated message includes the generated key 112 associated with the selected data 104′. In one example, the generated communication includes a universal resource identifier (URI), or other suitable address, of a data validation module 118, with the key 112 being incorporated into the URI. For example, the communication may include the URI:
http://audit.hp.com/Response.aspx?09F686761827CF8AE040578CB20B7491

Where 09F686761827CF8AE040578CB20B7491 is the generated key.

In one example the generated message includes text indicating to the owner the purpose of the email, and includes details of the select data 104′ that is to be validated by the owner. For example, the generated message may include the raw data 104′, or the data 104′ may be presented in a more user friendly format.

When the owner navigates to the URI using a suitable Internet browser application the data validation module 118 receives (302, FIG. 3) a response in the Form of a HTTP request message at the data validation module 118. The received response includes the generated key 112, and at 304 the data validation module 118 obtains (304) the key from the response.

The data validation module 118 then determines or identifies (306) the data that is associated with the obtained key. This may be achieved, for example, since the key generated by the key generator 110 was previously associated with data 104, as previously described.

At 308 the data validation module 118 determines (308) whether the data 104′ with the key is associated is valid.

In one example, where details of the data 104″ were included in the communication, the data validation module 118 generates a web page, or other web interface, that requests that the user viewing the website to identify whether the data in the communication is correct or incorrect. This may be done, for example, by presenting one hyperlink to select when the data is correct, and another to select when the data is incorrect. The data validation module 118 determines, based on the selection, whether the data identified in the communication is correct or incorrect. In other examples, other appropriate mechanisms may be used, such as a smart-phone application.

In a further example, the data validation module 118 obtains the data associated with the obtained key, generates a web page that displays at least part of the obtained data, and requests the user viewing the website to identify whether the data in the communication is correct or incorrect. Again, this may be done, for example, by presenting one hyperlink to select when the data is correct, and another to select when the data is incorrect. The data validation module 118 determines, based on the selection, whether the data identified in the communication is correct or incorrect,

At 310 the results of the data validation determination are stored in, or associated with, the data in the database 102.

In one example, once the data validation module 118 has obtained a key in response to a communication, the key is deleted or is disassociated with the data 104′ or 104, to prevent a subsequent response to the communication being made. For example, this would prevent a user from first responding that the data detailed in a communication was valid, and then subsequently responding that the data is invalid.

Referring now to FIG. 4, there is shown a block diagram of a data audit or data validation system 400 according to a further example of the present invention. Operation of elements of the system 400 is described with additional reference to FIGS. 5 and 6.

At 502 the data selector 108 selects, as previously described, a set of selected data 104′ for which the validity is to be verified.

At 504 a key generator 402 generates a pair of unique keys 414 and 416 for each selected data item 104′. As described previously, each key may be a universally unique identifier (UUID), a globally unique identifier (GUID), or the like, and be generated in any suitable manner. As will be described in more detail later, the keys 414 are used to indicate that selected data 104′ is valid, whereas keys 416 are used to indicate that selected data 104′ is invalid or incorrect.

At 506 the key generator associates, as described above, the generated keys 414 and 416 with the corresponding selected data items 104.

Once the keys 414 and 416 have been generated for a selected data item 104′ a communication module 418 obtains (508) contact details for the owner associated with the selected data 104.

The communication module 418 then generates (510) and sends (512) a communication to the obtained contact details of the owner associated with the selected data 104′. For example, if the obtained contact details relate to an email address or an SMS message, the communication module 418 generates and sends an appropriate email or SMS message.

In this example, the communication module 418 generates the communication to include details of the selected data 104′ and additionally to include two universal resource identifier (URI), or other suitable address indicators, of a data validation module 420. The key 414 is incorporated into one URI and the key 416 is incorporated into the other URI. For example, the communication may include the URIs:

http://audit.hp.com/
Response.aspx?09F686761827CF8AE040578CB20B7491
and
http://audit.hp.com/
Response.aspx?CD5B7769DFA5CEFE034080020825436

Where 09F686761827CF8AE040578CB2087491 is the first generated key and CD5B7769DFA5CEFE034080020825436 is the second generated key.

The communication is generated such that the URI including the key 414 is followed by a user to indicate that the details of the data included in the communication are correct or valid, whereas the URI including the key 416 is followed by a user to indicate that the details of the data are incorrect or are invalid. Suitable text may be included in the communication, and the URI and key may be hidden from the user by being configured as a hyperlink.

When the owner navigates to the URI using a suitable Internet browser application the data validation module 420 receives (602, FIG. 6) a response in the form of a HTTP request message at the data validation module 118. The received response includes one of the keys 414 or 416 including in the communication. At 604 the data validation module obtains a key from the response.

At 606 the data validation module 420 determines whether the obtained key is a key 414, indicating that the data associated therewith is valid or correct, or a key 416, indicating that the data associated therewith is invalid or incorrect. This may be achieved, for example, by performing a search or lookup of the generated keys 414 and 416.

The data validation module 420 then determines or identifies (608) the data 104′ that is associated with the obtained key. This may be achieved, for example, since the obtained key generated by the key generator 110 was previously associated with data 104′, as described above.

At 610 the data validity module 420 stores the determination, based on the obtained key, indicating whether the data 104′ detailed in the communication is valid or invalid.

In one example, once the data validation module 420 has obtained a key in response to a communication, both of the keys in the key pair are deleted or are disassociated with the data 104′ or 104, to prevent a subsequent response to the communication being made. For example, this would prevent a user from first responding that the data detailed in a communication was valid, and then subsequently responding that the data is invalid.

In further examples, when the data validation module 118 or 420 determine that selected data 104′ is invalid, the data validation module 118 or 420 generates a web page enabling the user to visualize the selected data 104′ and to either indicate which of the data is incorrect or enable the user to correct the data. Any user generated data is stored by the data validation module 420 in a suitable data store (not shown) for subsequent usage, for example, by a data auditor, or for inclusion in the database 102.

In one example, data validation module 420 obtains the Internet protocol address of the user terminal 116 sending the response, and may use this as a security check to ensure that only responses sent by users with an organizations network are accepted.

In a further example, as illustrated in FIG. 7, at least part of a data validation system, such as the data validation system 100 or 400, may be implemented using a microprocessor 702 coupled, via a communication bus 704, to a memory 706 and an input/output module 708. The memory 706 stores data validation system instructions comprising data selector instructions 710, key generator instructions 712, communication module instructions 714, and data validation module instructions 716. The instructions 710, 712, 714, and 716 are processor understandable instructions that when executed by the processor 702 provide functionality of a data validation system comprising a data selector module, a key generator module, a communication module, and a data validation module as described herein.

One advantage with the examples of the present invention is that no authentication of users or owners is required when responding to a communication. Accordingly, no user accounts need to be created. This is particularly advantageous in large organizations and businesses with many thousands of users and may represent a significant reduction in effort and resources, and hence cost.

A further advantage is that since the generated keys are associated with the data, an owner receiving a communication may delegate validation of the data by simply forwarding the communication to another person. The delegate then simply has to verify the data and to appropriately respond, through use of the URI embedded in the communication, to the data validation module 118 or 420.

It will be appreciated that examples of the present invention can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are examples of tangible machine-readable storage that are suitable for storing a program or programs that, when executed, implement examples of the present invention. Accordingly, examples provide a program comprising code for implementing a system or method as claimed herein and a machine readable storage storing such a program. Still further, examples of the present invention may be conveyed electronically via any medium such as a communication signal carried over a wired or wireless connection and examples suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

1. A method of verifying stored data, the data being associated with an owner, the method comprising:
selecting stored data to verify;
generating, for an item of the selected data a unique key;
associating the generated key with the corresponding data item;
sending a communication to the owner associated with a selected data item, the communication including the generated key associated with that selected data item, receiving a response to the communication, the response including a key;
determining from the response whether the data associated with the received key is valid; and
associating the determination with the data in the database.

2. The method of claim 1, further comprising, once a response to the communication has been received, generating a web page providing details of the data item associated with the received key and through which a user may confirm whether the data item is valid.

3. The method of claim 1, wherein the step of selecting selects a portion of the stored data based on a characteristic of what the stored data represents.

4. The method of claim 1, wherein the communication is one of: an email message, a short message system message, an instant communication message, and a telephone call.

5. The method of claim 1, wherein the step of generating a unique key generates a pair of unique keys, a first key of which is associated with the associated data item being valid, and a second key of which is associated with the associated data item being not valid, and wherein the step of sending a communication further comprises sending a communication including the pair of unique keys.

6. The method of claim 5, wherein the step of determining from the response whether the data associated with the received key is valid comprises:
determining the data item associated with the received key; and
determining whether the received key is associated with the data item being valid or is associated with the data item being invalid,

7. The method of claim 6, further comprising, disassociating a key or keys pair from a data item once the key or one of the key pairs has been received in a response.

8. The method of claim 1, further comprising determining an address of the owner associated with the stored data and wherein the step of sending the communication further comprises sending the communication to the determined address.

9. The method of claim 1 wherein the step of generating the communication further comprises including an address to which a response to the communication is to be sent,

10. Apparatus for verifying data stored in a database, the data being associated with an owner, the apparatus comprising:
a data selector to select data items in the database;
a key generator to generate, for each selected data item, a unique key and to associate the generated key with the corresponding data item;
a communication module to send, to an owner associated with a selected data item, a communication including the generated key associated with that selected data item; and
a data validation module to:
receive a response to the communication, the response including a key;
identify a data item associated with received key;
determine, from the response, whether the data item associated with the received key is valid; and
store the determined validity in association with the associated selected data item.

11. The apparatus of claim 10, wherein the data selector is further arranged to select a portion of the stored data based on a characteristic of what the data represents.

12. The apparatus of claim 10, wherein the data validation module is further arranged to generate a web page displaying details of the data item associated with the received key and through which a user may indicate whether the displayed details are valid or are not valid.

13. The apparatus of claim 12, wherein the communication module generates a communication including a universal resource indicator, URI, of the web page.

14. The apparatus of claim 10, wherein the key generator is further arranged to generate a pair of unique keys for a data item, a first one of the keys being associated with the data item being valid, and a second one of the keys being associated with the data item being not valid, and wherein the communication module is further arranged to generate a communication including the first and second keys.

15. A tangible, machine-readable medium that stores machine-readable instructions executable by a processor to provide a method of verifying stored data associated with an owner, the tangible machine-readable medium comprising:
machine readable instructions that, when executed by the processor, select a portion of the stored data for verification;
machine readable instructions that, when executed by the processor, obtain, for each item of the selected data, a pair of unique keys, a first key indicating that the selected data item is valid, and a second key indicating that the selected data item is not valid;
machine readable instructions that, when executed by the processor, associate each data item with its corresponding obtained pair of keys;
machine readable instructions that, when executed by the processor, send a communication to an address of the associate owner, the communication including the obtained pair of keys;
machine readable instructions that, when executed by the processor, receive a response to the communication, the response including a key;
machine readable instructions that, when executed by the processor, determine a data item associated with the received key;
machine readable instructions that, when executed by the processor, determine, based on whether the received key is the first or second key associated with the data item, whether the data item associated with the received key is valid or not valid; and
machine readable instructions that, when executed by the processor, store the determined data item validity in association with the data item.
